(19) United States
(12) Patent Application Publication
(10) Pub. No.: US 2022/0164500 A1
(43) Pub. Date: May 26, 2022

(54) INTELLIGENT ASSISTANTS FOR COMPUTER-AIDED DESIGN

(71) Applicant: Accenture Global Solutions Limited, Dublin (IE)

(72) Inventors: Dylan James Snow, Concord, CA (US); Ryanne Noor Ramadan, Lakewood, CA (US)

(21) Appl. No.: 17/455,699

(22) Filed: Nov. 19, 2021

Related U.S. Application Data
(60) Provisional application No. 63/116,228, filed on Nov. 20, 2020.

(51) Int. Cl. G06F 30/27; G06F 30/12

(52) U.S. Cl. CPC G06F 30/27; G06F 30/12

(57) ABSTRACT

Implementations are directed to a set of intelligent assistants for execution with a computer-aided design (CAD) program, one or more intelligent assistants of the set of intelligent assistants processing a product representation of a product using one or more of embeddings and ML models to provide functionality to progress a design of the product through a design process.

### CROSS-REFERENCE TO RELATED APPLICATION

This application claims the benefit under 35 U.S.C. § 119(e) of U.S. Patent Application No. 63/116,228, entitled “Intelligent Assistants For Computer-Aided Design,” filed Nov. 20, 2020, which is incorporated herein by reference in its entirety.

### BACKGROUND

Computer-aided design (CAD) is used across multiple industries for the design and manufacture of products. Generally, CAD programs boost the productivity of designers, reduce lead times in the concept-to-manufacture pipeline, and increase the overall quality of products. CAD programs enable designers to use computers to create, modify, analyze, and optimize product designs. Some CAD programs enable virtual testing of product designs prior to physical prototyping and/or manufacturing. The product design is stored in a computer-readable file (CAD file), which can be used in subsequent phases of the design process. For example, the CAD file can be read by a three-dimensional (3D) printer, which can print a physical copy of the product.

An issue that arises in use of CAD, is the multitude of product designs that are generated, in many cases, for the same product. Traditional CAD programs are either absent functionality or provide limited functionality for reuse of previous product designs. For example, in many cases, product designers may be unaware of previous product designs, or even if aware, be unable to find the CAD files recording the previous product designs. That is, for example, hundreds to thousands of CAD files could be provided, which would take longer to search through than to recreate the product in CAD. This is a particular problem in enterprises that employ a multitude of product designers. As a result, product designers quite frequently re-design products from scratch. This results in increasing the already significant number of CAD files that need to be stored and maintained, which burdens technical resources (e.g., processors, memory). This also results in complications in industries that are regulated. For example, and without limitation, aircraft parts and/or surgical equipment can require regulatory approval for use, which can be an onerous process. Situations frequently arise, in which CAD files for product designs that have already received regulatory approval are not available to a product designer, requiring the product designer to find another solution (e.g., re-design the product from scratch) extending the product design process and expending technical resources.

Another issue is that certain scenarios diminish the efficiencies CAD typically provides. For example, product design spans dimensions of mass manufacturing, niche manufacturing, and personalized manufacturing. For example, mass manufacturing implies product designs that are genericized to a population of consumers with little to no customization for sub-groups within the population, niche manufacturing implies product designs that are tailored to one or sub-groups within the population, and personalized manufacturing implies product designs that are customized to smaller sub-groups within the population, such as individuals. There is a drive across industries to move from mass manufacturing to personalized manufacturing. For example, personalized manufacturing can result in, among other things, lower waste, more customer engagement, greater customer analytics, greater customer satisfaction, as well region/language/age/other demographic-specific products. However, efficiencies gained through use of CAD programs in product designs can diminish in personalized manufacturing settings. For example, because a product is designed for a small sub-group of customers, or even an individual customer, the design process is reiterated multiple times for a product, each iteration for an individual or small sub-group.

### SUMMARY

Implementations of the present disclosure are generally directed to computer-implemented systems for intelligent assistants for computer-aided design (CAD). More particularly, implementations of the present disclosure are directed to a set of intelligent assistants that operates with a CAD program to provide efficiencies (e.g., time efficiencies, technical efficiencies) in product design processes. Further, the set of intelligent assistants reduces burdens in maintaining and providing search capabilities for libraries of product designs.

In some implementations, actions include receiving input to a CAD program representative of a product design, the input being used to provide a product representation including one of a graph representation and a boundary representation, processing the product representation using an intelligent assistant of a set of intelligent assistants to provide one of a set of similar product designs, a set of profiles to the product design, a set of segments of the product design, a set of variant product designs, and one or more auto-completions to the product design, receiving input to the CAD program representative of a selection of one or a similar product design, a profile to the product design, a segment of the product design, a variant product of the product design, and an auto-completion of the product design, defining a final product design at least partially based on the input representative of a selection of one or a similar product design, a profile to the product design, a segment of the product design, a variant product of the product design, and an auto-completion of the product design, and storing the final product design in a computer-readable file. Other implementations of this aspect include corresponding systems, apparatus, and computer programs, configured to perform the actions of the methods, encoded on computer storage devices.

These and other implementations can each optionally include one or more of the following features: the intelligent assistant includes a search assistant that processes a product embedding generated from the product representation to provide the set of similar product designs by comparing the product embedding to respective product embeddings of each of the similar product designs in the set of similar product design; the intelligent assistant includes a templating assistant that provides the set of profiles to the product design by processing the product representation to identify instances of node isomorphism between one or more nodes of the product representation and profile representations of each profile in the set of profiles; the intelligent assistant includes a segmentation assistant that provides the set of segments for the product design, each segment representing a sub-part of the product design by parsing the product representation of the product design into communities, determining a manufacturability for each community, and defining the set of segments based on a community and respective manufacturability; the intelligent assistant includes a design synthesis assistant that processes the product representation through a machine learning (ML) model to generate the set of variant product designs, each variant product design being an alternative to the product design; the intelligent assistant includes an auto-complete assistant that provides the set of auto-completions during progression of the product design by processing the product representation through a ML model to provide each auto-completion as a next-in-sequence predictions usable to progress the product design; and the graph representation represents objects and characteristics of objects of the product design, and the boundary representation represents boundaries and characteristics of boundaries of the product design.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example system that can execute implementations of the present disclosure.

FIGS. 2A and 2B depict an example graph representation and an example boundary representation, respectively

FIGS. 3A-3C depict representations corresponding to a search assistant in accordance with implementations of the present disclosure.

FIGS. 4A and 4B depict representations corresponding to a templating assistant in accordance with implementations of the present disclosure.

FIGS. 5A-5C depict representations corresponding to a segmentation assistant in accordance with implementations of the present disclosure.

FIGS. 6A-6C depict representations corresponding to a design synthesis assistant in accordance with implementations of the present disclosure.

FIGS. 7A and 7B depict representations corresponding to an auto-complete assistant in accordance with implementations of the present disclosure.

FIG. 8 depicts an example process that can be executed in accordance with implementations of the present disclosure.

Like reference symbols in the various drawings indicate like elements.

### DETAILED DESCRIPTION

Implementations of the present disclosure are generally directed to computer-implemented systems for intelligent assistants for computer-aided design (CAD). More particularly, implementations of the present disclosure are directed to a set of intelligent assistants that operates with a CAD program to provide efficiencies (e.g., time efficiencies, technical efficiencies) in product design processes. Further, the set of intelligent assistants reduces burdens in maintaining and providing search capabilities for libraries of product designs.

In some implementations, actions include receiving input to a CAD program representative of a product design, the input being used to provide a product representation including one of a graph representation and a boundary representation, processing the product representation using an intelligent assistant of a set of intelligent assistants to provide one of a set of similar product designs, a set of profiles to the product design, a set of segments of the product design, a set of variant product designs, and one or more auto-completions to the product design, receiving input to the CAD program representative of a selection of one or a similar product design, a profile to the product design, a segment of the product design, a variant product of the product design, and an auto-completion of the product design, defining a final product design at least partially based on the input representative of a selection of one or a similar product design, a profile to the product design, a segment of the product design, a variant product of the product design, and an auto-completion of the product design, and storing the final product design in a computer-readable file.

To provide context for implementations of the present disclosure, CAD is used across multiple industries for the design and manufacture of products. Generally, CAD programs boost the productivity of designers, reduces lead times in the concept-to-manufacture pipeline, and increases the overall quality of products. CAD programs enable designers to use computers to create, modify, analyze, and optimize product designs. Some CAD programs enable virtual testing of product designs prior to physical prototyping and/or manufacturing. The product design is stored in a computer-readable file (CAD file), which can be used in subsequent phases of the design process. For example, the CAD file can be read by a three-dimensional (3D) printer, which can print a physical copy of the product.

An issue that arises in use of CAD, is the multitude of product designs that are generated, in some cases, for the same product. Traditional CAD programs are either absent functionality or provide limited functionality for reuse of previous product designs. For example, in many cases, product designers may be unaware of previous product designs, or even if aware, be unable to find the CAD files recording the previous product designs. That is, for example, hundreds to thousands of CAD files could be provided, which would take longer to search through than to recreate the product in CAD. As a result, product designers quite frequently re-design products from scratch. This results in increasing the already significant number of CAD files that need to be stored and maintained, which burdens technical resources (e.g., processors, memory). This also results in complications in industries that are regulated. For example, and without limitation, aircraft parts and/or surgical equipment can require regulatory approval for use, which can be an onerous process. Situations frequently arise, in which CAD files for product designs that have already received regulatory approval are not available to a product designer, requiring the product designer to find another solution (e.g., re-design the product from scratch) extending the product design process and expending technical resources.

Another issue is that certain scenarios diminish the efficiencies CAD typically provides. For example, product design spans dimensions of mass manufacturing, niche manufacturing, and personalized manufacturing. For example, mass manufacturing implies product designs that are genericized to a population of consumers with little to no customization for sub-groups within the population, niche manufacturing implies product designs that are tailored to one or sub-groups within the population, and personalized manufacturing implies product designs that are customized to smaller sub-groups within the population, such as individuals. There is a drive across industries to move from mass manufacturing to personalized manufacturing. For example, personalized manufacturing can result in, among other things, lower waste, more customer engagement, greater customer analytics, greater customer satisfaction, as well region/language/age/other demographic specific products. However, efficiencies gained through use of CAD programs in product designs can diminish in personalized manufacturing. For example, because a product is designed for a small sub-group of customers, or even an individual customer, the design process is reiterated multiple times for a product, each iteration for an individual or small sub-group.

In view of this, implementations of the present disclosure provide a set of intelligent assistants that operates with a CAD program to provide efficiencies (e.g., time efficiencies, technical efficiencies) in product design processes. Further, the set of intelligent assistants reduces burdens in maintaining and providing search capabilities for libraries of product designs. As described in further detail herein, the set of intelligent assistants includes one or more of a search assistant, a templating assistant, a segmentation assistant, a design synthesis assistant, and an auto-complete assistant. In some implementations, one or more of the intelligent assistants in the set of intelligent assistants uses graph representations of partial designs and/or machine-learning (ML) models to provide respective functionality.

Implementations of the present disclosure are described in further detail herein with reference to CAD, sketch graphs, boundary representation, and object types, among other terms. In general, CAD includes CAD programs that enable users (e.g., product designers) to define data objects that represent a product (also referred to herein as a product design). For example, and without limitation, a CAD program enables users to incrementally add operations and constraints to construct a product within the CAD program. Example operations include, without limitation, drawing lines, circles, squares, extrusions, and the like. Example constraints include, without limitation, perpendicular, parallel, coincident, and the like. Example CAD programs include, without limitation, AutoCAD, SketchUp, Rhino, and FreeCAD. In some examples, a sketch graph can be described as a graph representation of a product that is internal to a CAD program. In some examples, a boundary representation (BRep) can be described as a geometric and topological description of the boundary of an object, the boundary being segmented into a finite number of bounded faces, each face being represented by its bounding edges and vertices. In some examples, a BRep can be provided as a network of boundary components.

In some examples, a product can be internally represented within a CAD program as a sequence of operations (e.g., circle, arc, line) and constraints (e.g., perpendicular, coincident, parallel) that are progressively recorded in an object representation. In some examples, the object representation is provided as a sketch graph (or sketchgraph) that is executed by a solver to produce visualizations of the product (e.g., 3D images, 2D images) displayed by the CAD program. In some examples, the object representation is provided as a BRep that is executed by a solver to produce visualizations of the product (e.g., 3D images, 2D images) displayed by the CAD program. In some examples, the object representation (sketch graph, BRep) is described in computer-readable code that defines, among other things, components, properties of components, relationships between components, properties of relationships, and boundaries. For example, components can be represented as nodes (also referred to as vertices) and relationships can be represented as edges between nodes.

In some examples, the object representation can be visualized as sets of nodes and edges between nodes that visually depicts operations and constraints. In some examples, the object representation is provided in computer-readable code that encodes operations and constraints (e.g., in a sketchgraph) and/or boundaries (e.g., in a BRep). In some examples, the object representation is provided as a time-series array (e.g., recorded in a table) that lists operations and constraints.

Example object types can include, without limitation, 2D, 2.5D, and 3D. In some examples, 2D refers to a 2D image (e.g., a screenshot of a 3D model, referred to as a render). In some examples, 2.5D refers to a set 2D images (e.g., a set of screenshots of a 3D model), each 2D image being from different angle. The set of 2D images collectively represent a ‘pseudo-3D’ representation of a product, capturing some sense of the depth of the product in 3D.

In some examples, 3D refers to a 3D model. Example types of 3D models can include a voxel model, a point cloud model, and a mesh model. In some examples, a voxel model represents a product as a set of regular sized cubes placed within a 3D grid (e.g., representing the product in a Minecraft-style). In general, a point cloud model can be described as a multi-dimensional point representation of an object that includes a set of n points defined by a coordinate system. In some examples, each point is represented by coordinates (e.g., [x, y, z]). In some examples, additional dimensions can be added to the representation of each point by, for example, determining normals, local features (e.g., color channels (RGB)), and/or global features. In general, a mesh model can be described as a multi-dimensional mesh representation of an object that includes a mesh of interconnected polygons (e.g., triangles), each shape representing a face of the object. More particularly, a mesh model is represented as mesh data that includes sets of vertices, edges, and faces, where vertices are connected with edges and closed sets of edges form faces. In some examples, the faces are polygons, such as triangles. Implementations of the present disclosure are described in further detail herein with non-limiting reference to triangles. In some examples, the mesh model includes a set of n faces, and each face is defined as a set of initial values. In some examples, the set of initial values includes face information and neighbor information. Examples of face information include center (e.g., coordinates [x, y, z] of the center point), corner (e.g., vectors from the center point to each vertex), and normal (e.g., unit normal vector). Example neighbor information includes neighbor index (e.g., indexes of connected faces).

Implementations of the present disclosure are also described in further detail with non-limiting reference to clustering and embedding. Clustering can generally be described as a mathematical operation that groups data points into clusters. It can be done automatically, or data points can have a label associated with them that already organizes them into clusters. In some examples, clustering groups objects based on either undefined (unsupervised) or defined (supervised) characteristics. For example, 3D polygon models of chairs could be grouped by style (e.g., French, modern, Bauhaus). Embedding can generally be described as a mathematical operation that converts a representation into a vector representation (e.g., a vector of numbers of k dimension). For example, an object representation, such as a sketch graph and/or a BRep, can be converted to a vector representation using embeddings. In some examples, an embedding (vector representation) includes multiple dimensions (e.g., a vector having p dimensions).

Implementations of the present disclosure are also described in further detail with non-limiting reference to generative design. In some examples, generative design can be described as an iterative design process that involves a computer-executable program that generates outputs that meet certain constraints. In some examples, the computer-executable program includes a ML model (e.g., generative adversarial network (GAN)). In some examples, generative design can include generating a non-existing design from one or more existing designs, the one or more existing designs being used as constraints for the non-existing design. In some examples, generative design can include generating a non-existing design as a combination (e.g., an average) of existing designs within a group of designs, generating a random design relative to existing designs within a group of designs, and generating a non-existing design between groups of designs. By way of non-limiting example, existing chair designs can be provided in groups (cluster) by style (e.g., a modern group, a French group, a Windsor group, and a desk group). In some examples, a new (non-existing) chair design can be generatively designed as a combination of chair designs within a group. For example, a new chair design of a French style can be generated as a combination (e.g., average) of existing chair designs within the French group. In some examples, a new (non-existing) chair design can be generatively designed as a random of chair designs within a group. For example, a new chair design of a French style can be generated to include a random selection of features of existing chair designs within the French group. In some examples, a new (non-existing) chair design can be generatively designed as a combination (e.g., average) of chair designs between groups. For example, a new chair of a modern-French style can be generated as a combination of chair designs in the modern group and chair designs in the French group.

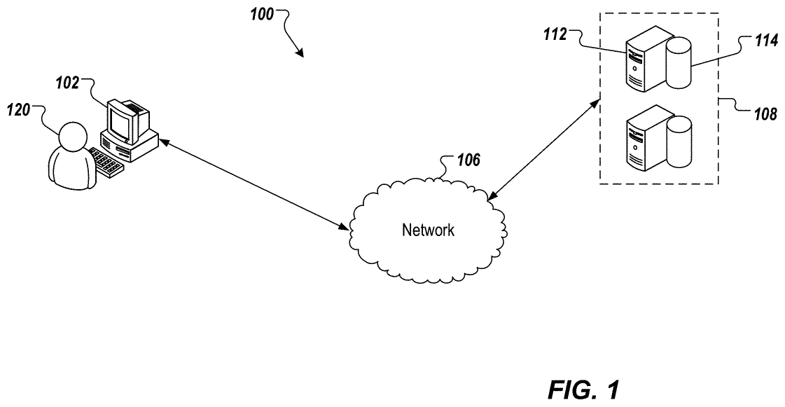

FIG. 1 depicts an example system 100 that can execute implementations of the present disclosure. The example system 100 includes a computing device 102, a back-end system 108, and a network 106. In some examples, the network 106 includes a local area network (LAN), wide area network (WAN), the Internet, or a combination thereof, and connects web sites, devices (e.g., the computing device 102), and back-end systems (e.g., the back-end system 108). In some examples, the network 106 can be accessed over a wired and/or a wireless communications link.

In some examples, the computing device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In the depicted example, the back-end system 108 includes at least one server system 112 and data store 114 (e.g., database).

In some examples, the computing device 102 can execute a CAD program. In some examples, the at least one server system 112 hosts a CAD program that enables a user 120 to create or edit a product design recorded in a CAD file. For example, the user 120 can interact with the CAD program over the network 106 using the computing device. In some examples, the CAD program can be provided as a web-based application, in which user interfaces (Uls) are displayed by a web browser application executed on the computing device 102. The CAD program enables a user 120 to create or edit a product design recorded in a CAD file. In some examples, the CAD program includes or operates with a set of intelligent assistants in accordance with implementations of the present disclosure. In some examples, the set of intelligent assistants can be provided as part of the CAD program (e.g., integrated in the CAD program). In some examples, the set of intelligent assistants can be provided as a plug-in to the CAD program (e.g., a computer-executable program that functions as an extension to the CAD program).

Implementations of the set of intelligent assistants are described in further detail herein with reference to graph representations and boundary representations of products. It is contemplated, however, that implementations of the present disclosure can be realized using any appropriate representation of a product. For example, a product can be represented as a point cloud model or a mesh model, both of which are described in further detail herein.

As described in further detail herein, one or more of the intelligent assistants of the present disclosure can process an object representation of a product to provide a vector representation (also referred to as an embedding). That is, an object representation of a product can be processed to embed features of the object representation in a multi-dimensional vector space. In some examples, and in the case of a graph representation or a boundary representation, the graph representation or boundary representation (e.g., the computer code underlying the graph/boundary representation) can be provided as input to an embedding program, which provides a vector representation as output. A graph embedding can be described as a transformation of a graph to a vector or a set of vectors. A boundary embedding can be described as a transformation of a boundary network (a type of graph) to a vector or a set of vectors. Whether a graph embedding or a boundary embedding, the resulting vector representation can be referred to as a product embedding (e.g., a vector representation of a product). In some examples, the product embedding can capture the node-to-node relationships, and other relevant information about a graph, sub-graph within a graph, and nodes. Example product embeddings (vector representations) can include, without limitation, a set of vectors (e.g., multiple vectors, each vector having multiple dimensions) and a single vector (e.g., a vector having multiple dimensions).

In some examples, a neural network can be used to predict a class that a particular product belongs to. For example, the neural network processes a product representation and outputs a set of classes that the product is predicted to belong to (e.g., process a product representation of a desk and outputs a set of classes including desk, table, bench, chair, each class having a score indicating a probability of the product belonging to the respective class). In processing the product representation, the neural network generates one or more vector representations of the product (product embeddings), at least one vector representation being output from one or more layers of the neural network. In some examples, a vector representation of one of the layers can be used for processing by one or more intelligent assistants, as described in further detail herein. For example, a global feature vector that is output by a layer of the neural network before classification can be used as the vector representation of the product.

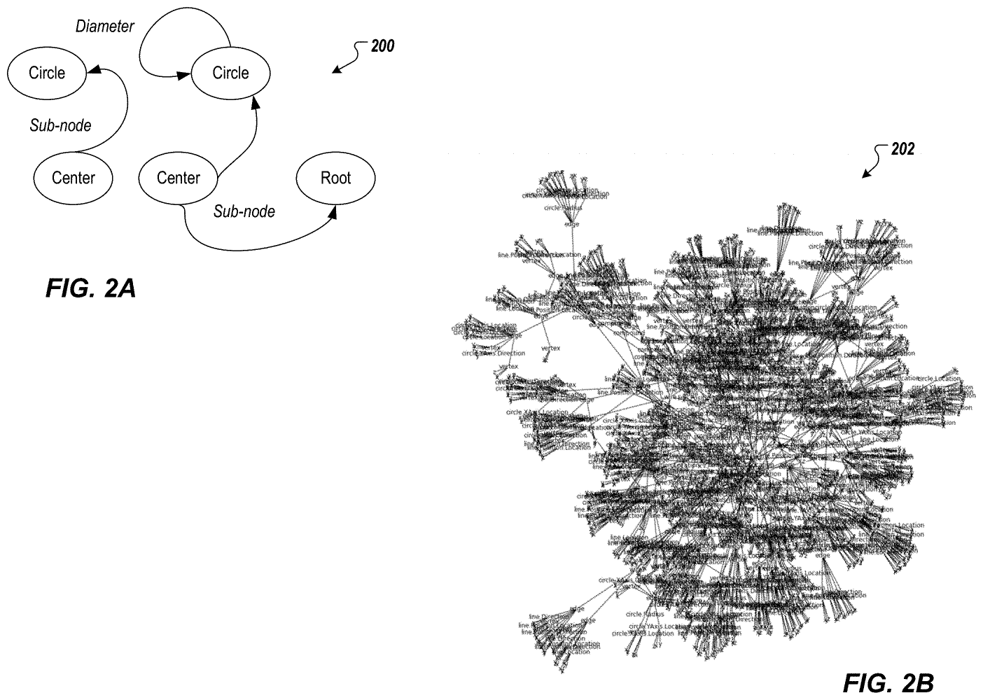

FIGS. 2A and 2B depict an example graph representation 200 and an example boundary representation 202, respectively. The example graph representation 200 is representative of a sketch graph and the example boundary representation 202 is representative of a BRep. In some examples, the graph representation 200 represents objects or characteristics of objects that a product is composed of (e.g., circles, planes) and relationships between objects and/or characteristics of objects. For example, nodes of the graph representation 200 represent objects and/or characteristics of objects and edges represent relationships between nodes. In some examples, the boundary representation 202 represents boundaries of characteristics of boundaries of a product. For example, nodes of the boundary representation 202 represent boundaries and/or boundaries of objects and edges represent relationships between nodes. As discussed herein, a product representation can be provided and can include either a graph representation or a boundary representation among other possible representations (e.g., point cloud, mesh).

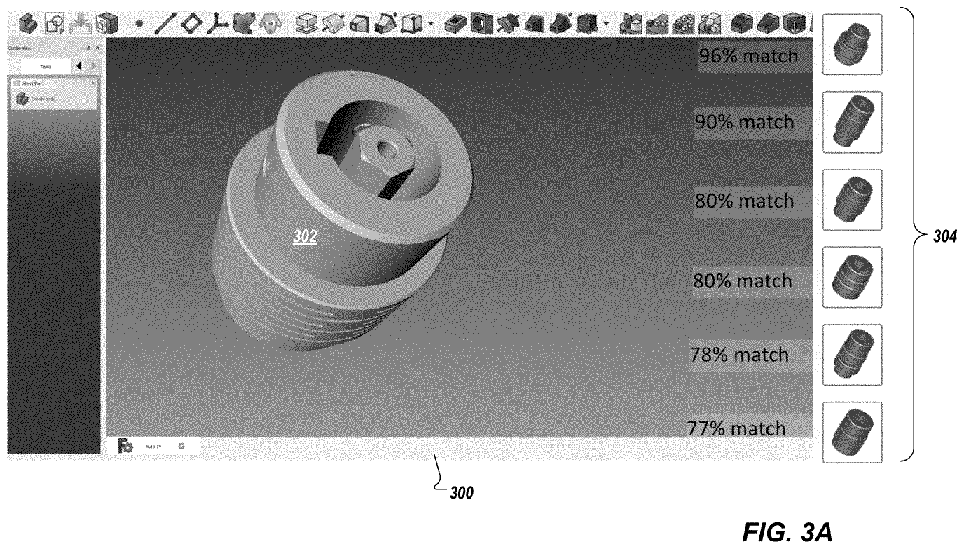

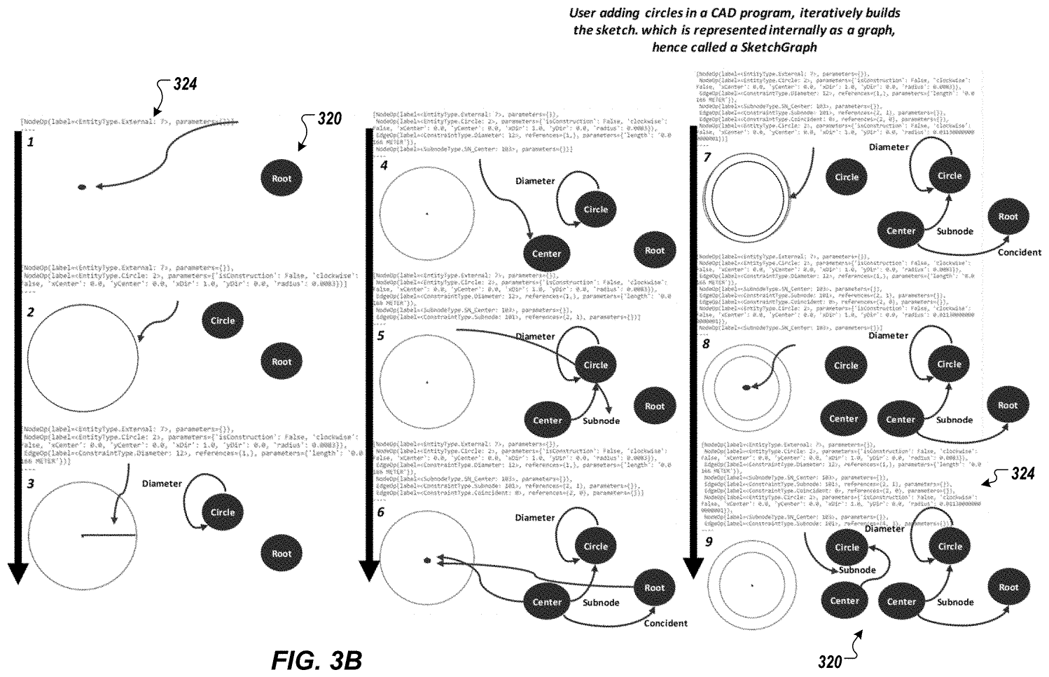

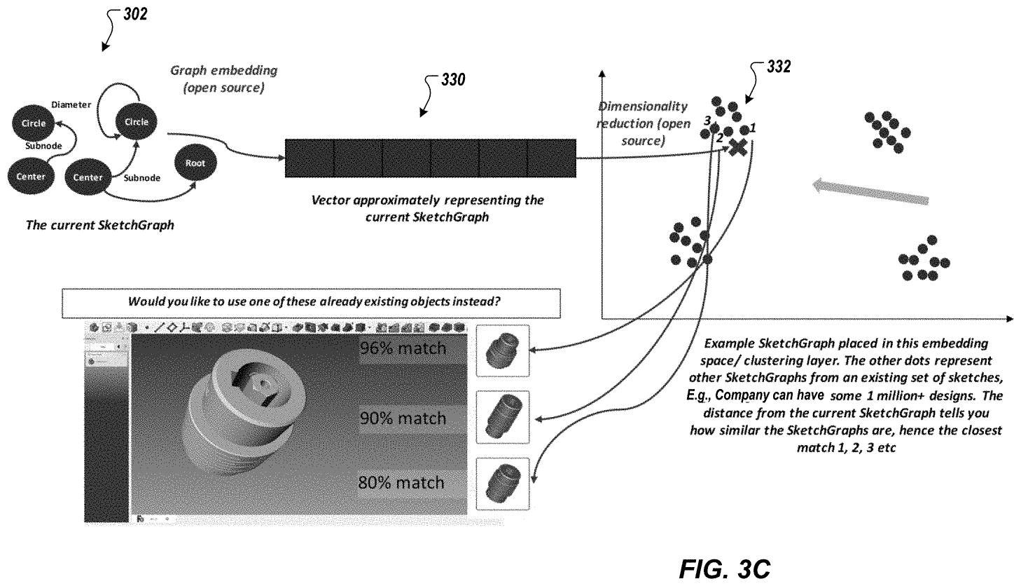

FIGS. 3A-3C depict representations corresponding to a search assistant in accordance with implementations of the present disclosure. In some implementations, the search assistant reviews a product representation during a progression of a current product design, provides a product representation of the product design at respective instances of the progression, and identifies, based on the product representation, one or more previous product designs to recommend to the product designer. That is, as the product progresses, a product representation is provided, which can be used to identify one or more previous product designs that the product is progressing toward.

With particular reference to FIG. 3A, a UI 300 displays a visualization 302 of a product. For example, the product can be designed by a user, the user progressively designing the product using the CAD program. In some implementations, the search assistant processes a product representation to provide a set of search results 304. In some examples, the set of search results includes one or more stored products that have a level of similarity to the product in a current state of design. In this sense, a stored product can be considered an existing product design that is stored in a library of product designs. In some examples, a stored product includes a product that had been previously designed and is stored in a CAD file that is accessible to the CAD program. In some examples, each stored product in the set of stored products 304 is associated with a degree of similarity representing a level of similarity between the product and a respective stored product. In some examples, the user can select a stored product from the set of stored products 304.

In further detail, and with particular reference to FIG. 3B, as a product is designed, the product transitions along a path of states. In some examples, each state represents a change to the product by the user. FIG. 3B depicts a non-limiting example of a product transitioning along a path of states. In the example of FIG. 3B, in a first state, a root is defined by the user (e.g., a center of a to-be-drawn circle), in a second state, a circle is drawn relative to the root, in a third state, a diameter of the circle is defined by the user, continuing though to a ninth state, in which concentric circles have been drawn. In the depicted example, in each state, the product is represented as a graph representation, the graph representation changing across states as the product transitions between states. In some examples, the graph representation is provided as a set of nodes and a set of edges, each edge representing a relationship between nodes in the set of nodes. In the example of FIG. 3B, a graph representation 320 transitions from a single node (representing the product in the first state) with no edges to multiple nodes and multiple edges (representing the product in the ninth state).

In some examples, the graph representation (also referred to as a sketch graph) is an internal representation of the product that is processed by the CAD program. That is, the graph representation is not automatically displayed to the user. In some examples, the user can view the graph representation. In some examples, the graph representation is provided as a visual graph (e.g., as the graph representation 320 of FIG. 3B). In some examples, the graph representation is provided as computer-readable code. For example, portions of computer-readable code 324 corresponding to the visual graph representation 320 are depicted in the example of FIG. 3B.

As described in further detail herein, the graph representation of a state can be processed to generate a set of search results. In some examples, the graph representation of a state is processed in response to user input requesting a set of search results to be provided for the state. In some examples, the graph representation of each state is automatically processed to provide a set of search results for each state. In this manner, search results can be automatically provided for each state as the design of the product progresses across states.

In some implementations, one or more stored products can be determined to be sufficiently similar to the product and included in a set of search results to be displayed. For example, for a state, the graph representation is processed to provide a vector representation. In some examples, and as introduced above, a vector representation can be provided as a graph embedding. The vector representation is compared to one or more vector representations of one or more stored products to determine a degree of similarity therebetween. In some examples, a degree of similarity can be determined as a difference between vector representations. In some examples, a difference can be determined based on a dot product of the vector representations.

In some examples, a stored product having a vector representation that is determined to be sufficiently similar to the vector representation of the product is included in the set of search results. In some examples, whether the vector representation of the product and the vector representation of a stored product are sufficiently similar can be determined based on a difference value, which represents a difference between the vector representation of the product and the vector representation of the stored product. In some examples, if the difference value is less than or equal to a threshold difference, the vector representation of the product and the vector representation of the stored product are determined to be sufficiently similar and the stored product is included in the set of search results. In some examples, if the difference value is greater than the threshold difference, the vector representation of the product and the vector representation of the stored product are determined to not be sufficiently similar and the stored product is not included in the set of search results.

In some examples, dimensionality reduction can be used to reduce the dimensionality of vector representations for comparison. Dimensionality reduction can be described as the transformation of data from a high-dimensional space into a low-dimensional, such that the low-dimensional representation retains some meaningful properties of the high-dimensional representation. For example, a graph representation can be processed through an embedding program to provide an initial vector representation having a first dimensionality. The initial vector representation can be processed through a dimensionality reduction program to provide a vector representation having a second dimensionality that is less than the first dimensionality. In some examples, reducing dimensionality enables more efficient comparison of vector representations (e.g., reduced burden on computer processing and memory).

With particular reference to FIG. 3C, a vector representation 330 can be provided for the graph representation 302 (e.g., corresponding to the ninth state of FIG. 2B). For example, the graph representation 302 (e.g., the computer code 324 underlying the graph representation) can be provided as input to an embedding program, which provides the vector representation 330 (as a graph embedding). The vector representation 330 is compared to vector representations 332 of stored products to provide a set of search results.

Although a graph representation is depicted in the examples of FIGS. 3A-3C, it is contemplated that implementations of the present disclosure can be realized using a boundary representation as the product representation, as described herein. For example, as a product design progresses, a boundary representation of the product design likewise progresses (e.g., nodes and edges are added). As introduced, the boundary representation (also referred to as a sketch graph) is an internal representation of the product that is processed by the CAD program. That is, the boundary representation is not automatically displayed to the user. In some examples, the user can view the boundary representation. In some examples, the boundary representation is provided as a visual graph or network (e.g., as the boundary representation 202 of FIG. 2B). In some examples, the boundary representation is provided as computer-readable code.

As similarly described herein with respect to the graph representation, the boundary representation of a state can be processed to generate a set of search results. In some examples, the boundary representation of a state is processed in response to user input requesting a set of search results to be provided for the state. In some examples, the boundary representation of each state is automatically processed to provide a set of search results for each state. In this manner, search results can be automatically provided for each state as the design of the product progresses across states.

In some implementations, one or more stored products can be determined to be sufficiently similar to the product and included in a set of search results to be displayed. For example, for a state, the boundary representation is processed to provide a vector representation. In some examples, and as introduced above, a vector representation can be provided as a boundary embedding. The vector representation is compared to one or more vector representations of one or more stored products to determine a degree of similarity therebetween. In some examples, a degree of similarity can be determined as a difference between vector representations. In some examples, a difference can be determined based on a dot product of the vector representations.

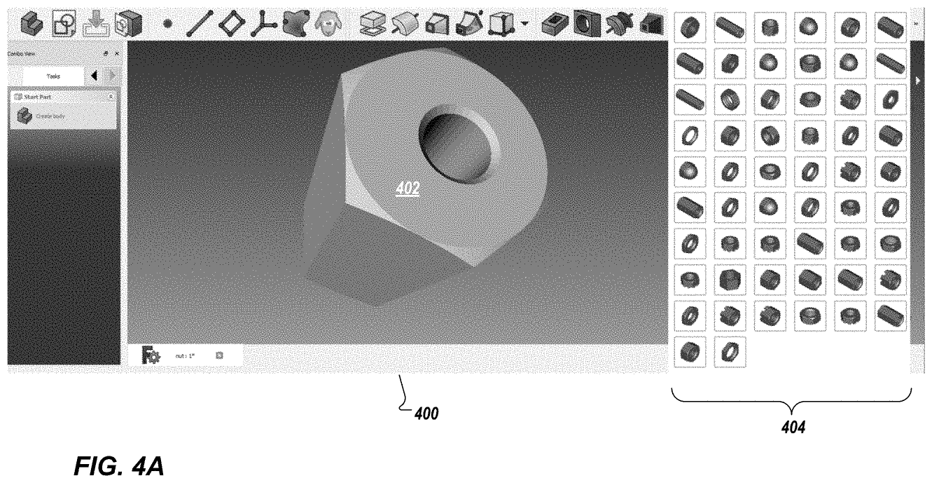

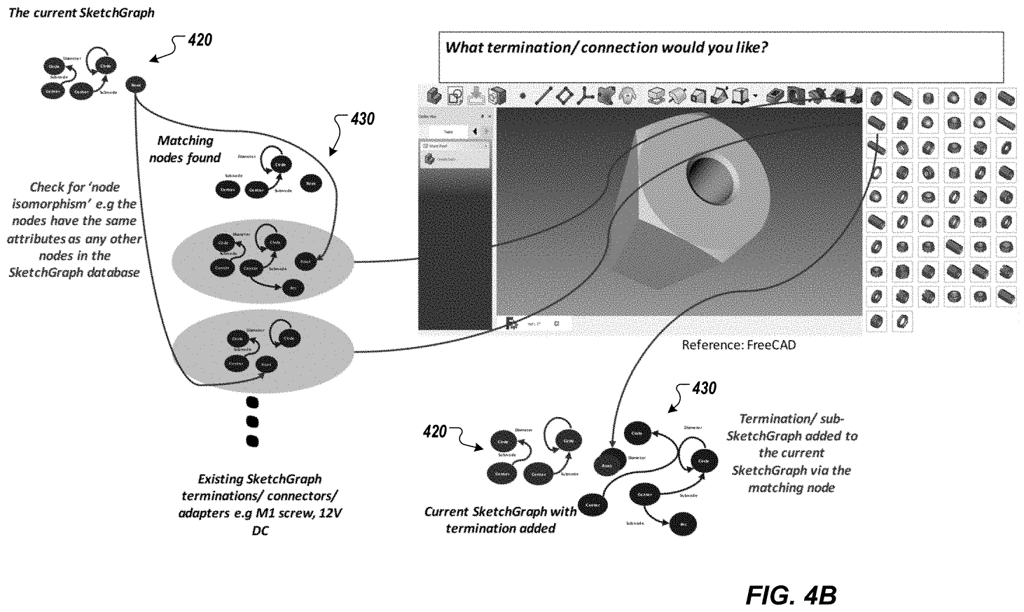

FIGS. 4A and 4B depict representations corresponding to a templating assistant in accordance with implementations of the present disclosure. In some implementations, the templating assistant recommends one or more of adapters, terminators, and connectors for a product design and auto-completion of the product design based on one or more selections by the product designer. In some examples, the templating assistant reviews a product representation during a progression of a current product design, checks for node isomorphism between one or more nodes of the current product design and one or more profiles, and recommends one or more profiles (e.g., adapters, terminators, and connectors) for a product design based on identified node isomorphism.

In further detail, there are thousands of adapters, terminations, and connectors that could be used with different shapes (e.g., M-series screws, gas pipes, electrical sockets). When designing a product, the templating assistant suggests a set of profiles (e.g., threaded screw female, unthreaded screw male, tapered threaded female, conical) to be incorporated with the product. This enables easy conversion between connector ends, for example, and auto-completion of adding that connector.

As described in further detail herein, the product representation of a state can be processed to generate a set of profiles. In some examples, the product representation of a state is processed in response to user input requesting a set of profiles to be provided for the state. In some examples, the product representation of each state is automatically processed to provide a set of profiles for each state. In this manner, profiles can be automatically provided for each state as the design of the product progresses across states.

In some examples, one or more nodes of a product representation of the product are compared to nodes of profile representations of profiles. In some examples, nodes are compared to check for node isomorphism. Node isomorphism can be described as existing between nodes that have a sufficiently similar set of attributes and sufficiently similar attribute values. In some examples, comparing nodes can be achieved by providing a node vector representation (node embedding) for each node, and comparing the node vector representations (e.g., calculating a dot product of the node vector representations). If a difference between the node vector representations is below w threshold difference, the nods can be determined to be sufficiently similar.

In some examples, the user can select a profile from the set of profiles. In some examples, in response to the user selection, the profile can be integrated into the product. For example, the product representation can be extended to include a profile representation of the profile based on the isomorphic nodes (i.e., matching nodes) between the product representation and the profile representation.

With particular reference to FIG. 4A, a UI 400 displays a visualization 402 of a product. For example, the product can be designed by a user, the user progressively designing the product using the CAD program. In some implementations, the templating assistant processes, in the example of FIG. 4A, a product representation provided as a graph representation to provide a set of profiles 404. In some examples, each profile in the set of profiles 404 is provided as one of a termination, a connector, and an adapter that can be incorporated into the product. With particular reference to FIG. 4B, a node of a graph representation 420 for a state can be compared to nodes of graph representations 430 of respective profiles to populate a set of profiles (e.g., including profiles having nodes that are isomorphic (match) nodes of the product). While graph representations are depicted in FIG. 4B, it is contemplated that boundary representations can be used as the product representation, as described herein.

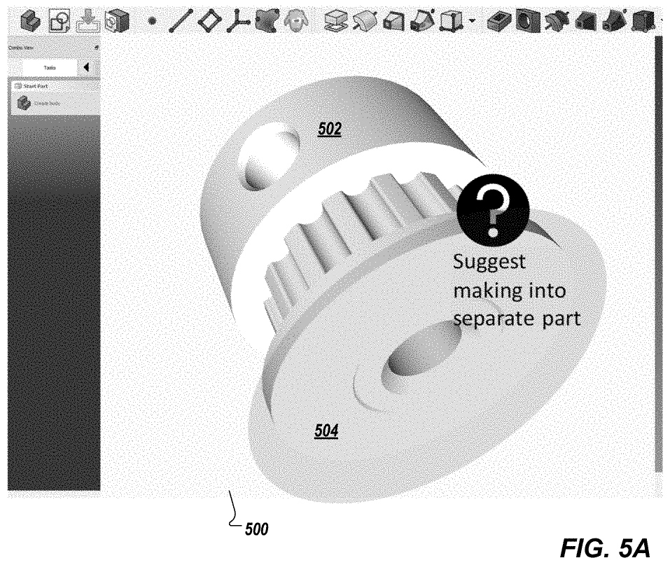

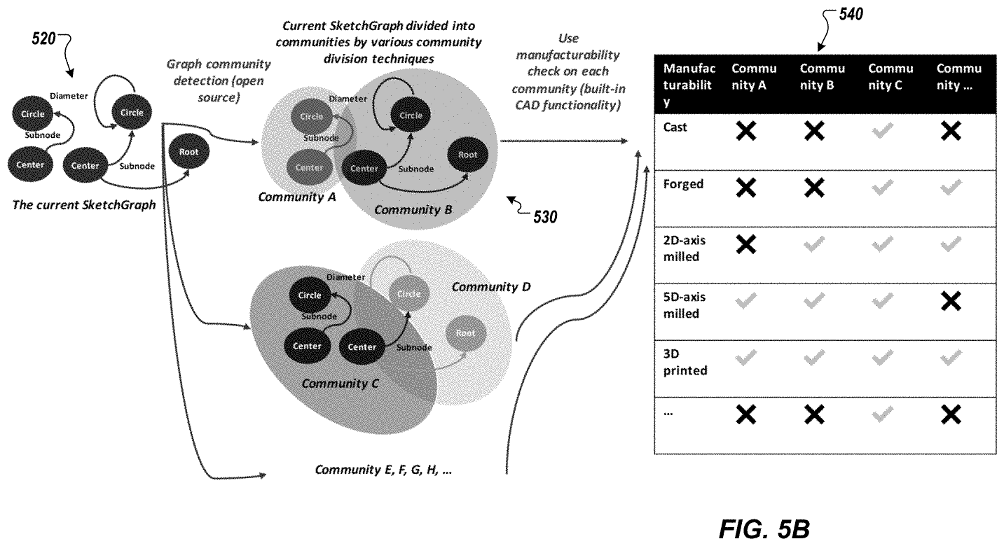

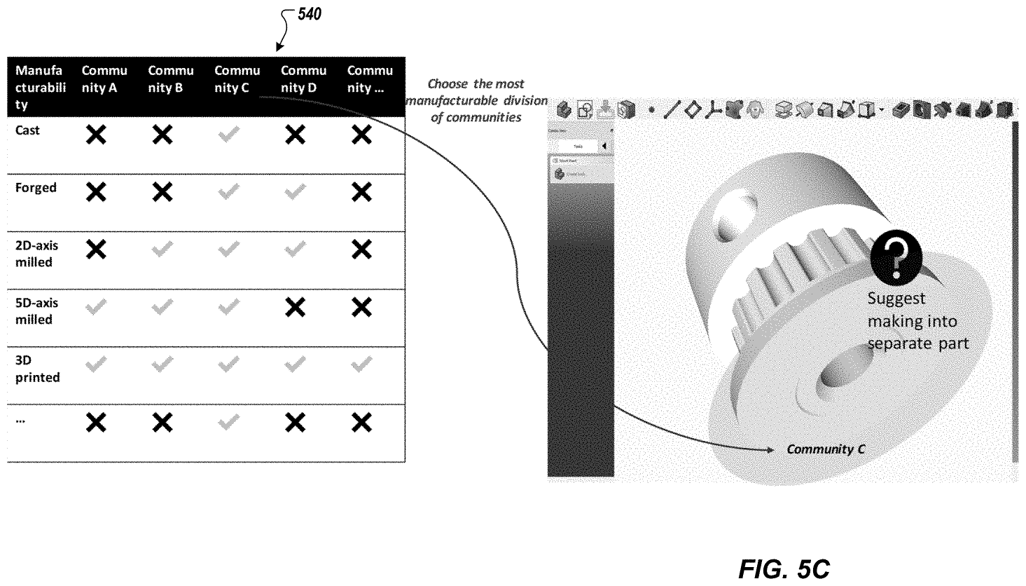

FIGS. 5A-5C depict representations corresponding to a segmentation assistant in accordance with implementations of the present disclosure. In some implementations, the segmentation assistant recommends one or more segments for a current product design, each segment representing a sub-part of the current product design. In some examples, the segmentation assistant parses a product representation (graph representation, boundary representation) of the current product design into communities, determines a manufacturability for each community, and recommends the one or more segments based on a community and respective manufacturability.

In further detail, manufacture of products can have varying degrees of complexity and resulting cost depending on how the product is to be manufactured. Example manufacturing processes can include, without limitation, casting, forging, 2D-axis milling, 5D-axis milling, and 3D printing. Manufacturing complexity and cost can increase depending on the type of manufacturing required. For example, the cost to produce a part from cheapest to most expensive might be ordered as: die extruding, cold-rolling, lathing, CNC milling, 3D printing. In some implementations, the segmentation assistant of the present disclosure suggests segments (sub-parts) that the product could be parsed into. In some examples, the segment assistant parses segments in response to determining that the segmentation would be cheaper and/or less complex to manufacture than the product as a whole.

In some implementations, the segmentation assistant processes the product representation of a state to determine one or more segments that the product can be parsed into. In some examples, the product representation of a state is processed in response to user input requesting a set of segments to be provided for the state. In some examples, the product representation of each state is automatically processed to provide a set of segments for each state. In this manner, segments can be automatically provided for each state as the design of the product progresses across states.

In some implementations, the segmentation assistant processes the product representation through one or more community division programs to identify sets of communities within the product representation. In some examples, each set of communities includes two or more communities within the product representation. In some examples, each community can be described as a sub-graph of the product representation. In some implementations, manufacturability of each community in a set of communities is determined for each manufacturing process in a set of manufacturing processes. For example, each community (sub-graph) can be processed using a manufacturability program, which provides output indicating whether the community can be manufactured for each manufacturing process in the set of manufacturing processes. In some examples, a community is recommended as a potential segment, if the community can be manufactured by each manufacturing process in the set of manufacturing processes.

With particular reference to FIG. 5A, a UI 500 displays a visualization 502 of a product. For example, the product can be designed by a user, the user progressively designing the product using the CAD program. In some implementations, the segmentation assistant processes a product representation, provided as a graph representation in the example of FIGS. 5A and 5B, to recommend one or more segments 504 that the product can be parsed into. As depicted in FIG. 5B, a graph representation 520 is processed through one or more community division programs to identify sets of communities 530 within the graph representation 520. In some examples, each set of communities 530 includes two or more communities within the graph representation 520. In some examples, manufacturability of each community in a set of communities 530 is determined for each manufacturing process in a set of manufacturing processes. For example, each community (sub-graph) can be processed using a manufacturability program, which provides output 540 indicating whether the community can be manufactured for each manufacturing process in the set of manufacturing processes. As depicted in FIG. 5C, a community (e.g., Community C) of a set of communities can be suggested for segmentation (e.g., in response to determining that the community can be manufactured using any of the manufacturing processes in the set of manufacturing processes). While graph representations are depicted in FIG. 5B, it is contemplated that boundary representations can be used as product representations, as described herein.

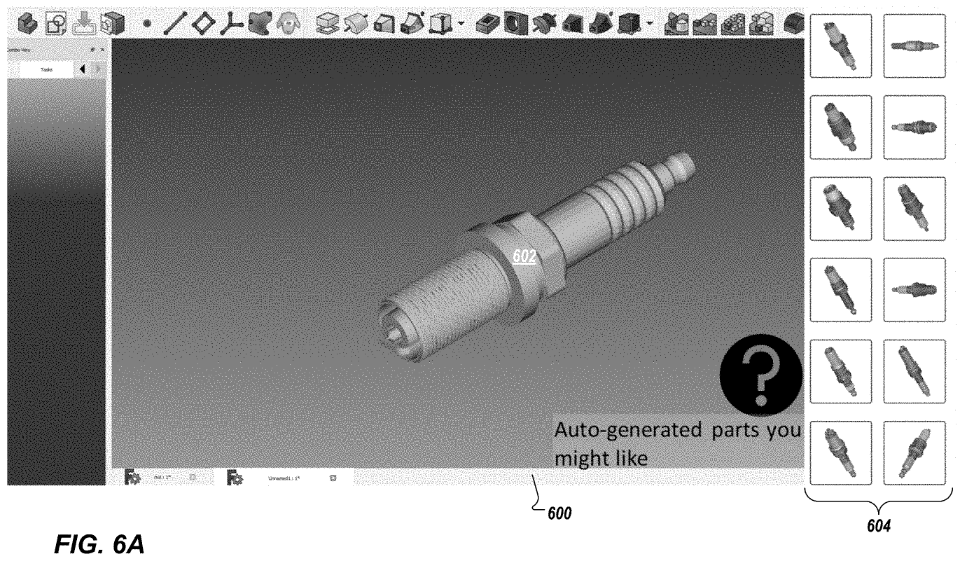

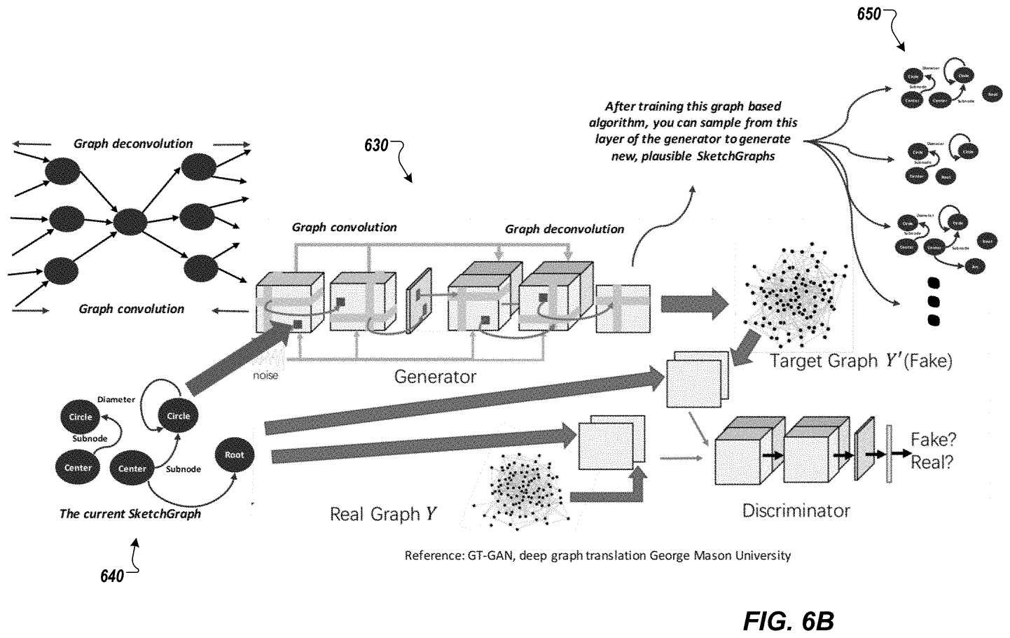

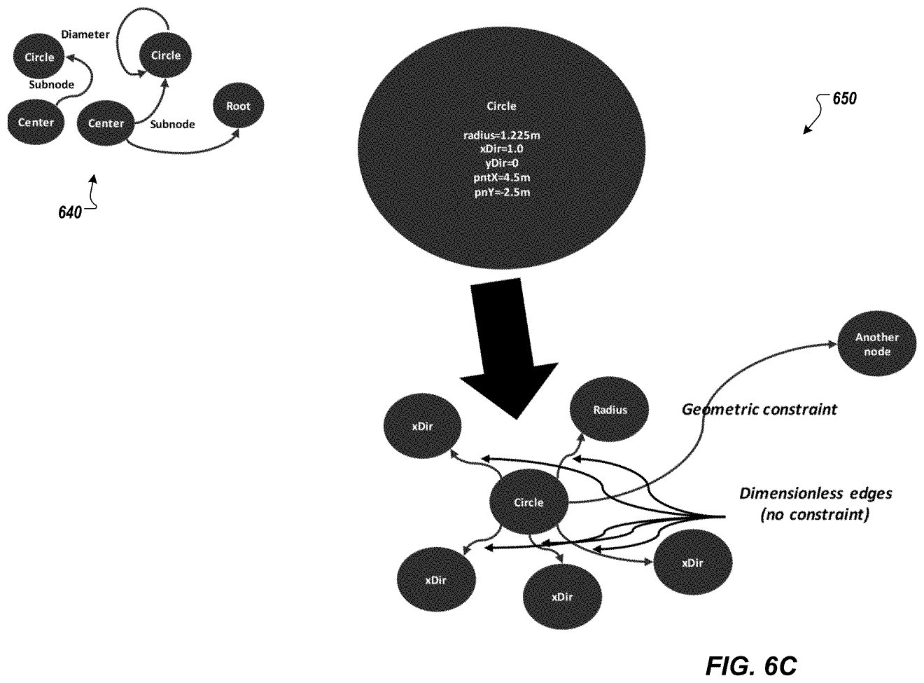

FIGS. 6A-6C depict representations corresponding to a design synthesis assistant in accordance with implementations of the present disclosure. In some implementations, the design synthesis assistant reviews a current product design and recommends one or more alternative designs. In some examples, the design synthesis assistant processes a product representation of the current product design through a ML model to generate one or more variation product representation, each variation product representation being an alternative design that can be recommended to the product designer.

As described in further detail herein, the product representation of a state can be processed to generate a set of design variations. In some examples, the product representation of a state is processed in response to user input requesting a set of design variations to be provided for the state. In some examples, the product representation of each state is automatically processed to provide a set of design variations for each state. In this manner, design variations can be automatically provided for each state as the design of the product progresses across states.

In some implementations, the design synthesis assistant processes products during design and generates a set of design variations. In some examples, each design variation is a representation of respective variation (e.g., future state, change of state(s)) of the product as a potential direction the design could take. This differs from the search assistant and the templating assistant, for example, in that the design synthesis assistant does not suggest existing products and/or profiles. Instead, the design synthesis assistant uses a current state of a product in the design process to suggest alternative states that the product could take as potential variations.

In further detail, in some implementations, the design synthesis assistant processes a product representation through one or more ML models to provide the set of design variations. In some examples, the one or more ML models processes the product representation to extend the product representation by deleting, adding, and/or modifying nodes and/or edges in different variations. That is, for example, each design variation in the set of design variations is based on a variation product representation, which can be described as including one or more modifications relative to the product representation (i.e., the product representation input to the one or more ML models).

An example ML model includes, without limitation, GT-GAN, which is described in detail in Deep Graph Translation, Guo et al., Jun. 22, 2018, which is expressly incorporated herein by reference in the entirety. GT-GAN can be described as GAN that learns a conditional generative model as a graph translator conditioned on an input graph and to generate a target graph. In the context of the present disclosure, the product representation of the product is provided as an input graph, and the variation product representation is provided as a target graph. In general, GT-GAN includes a graph generator (also referred to as a graph translator) and a graph discriminator. The graph generator provides the target graph (variation product representation) as output and includes a graph encoder and a graph decoder.

With particular reference to FIG. 6A, a UI 600 displays a visualization 602 of a product. For example, the product can be designed by a user, the user progressively designing the product using the CAD program. In some implementations, the design synthesis assistant processes a graph representation to provide a set of design variations 604. With particular reference to FIG. 6B, the design synthesis assistant processes a graph representation 640 using a ML model 630 to generate one or more variation graph representations 650. In the example of FIG. 6B, the ML model 630 is provided as GT-GAN, introduced above. It is contemplated, however, that any appropriate ML model can be used. As depicted in FIG. 6B, the variation graph representations 650 are provided as output of a generator of the GT-GAN.

With particular reference to FIG. 6C, another implementation is depicted. In this example, the graph representation 640 can be pre-processed to be representative of a molecule for processing through the ML model. For example, in some instances, a variational autoencoder (VAE) of the ML model operates on with an enumeration (enum) on the edge and node type. This is because, in this example, the VAE works on molecule generation (e.g., C—C═O—H—Al, with only 4 types of bonds and 20 types of atoms). In view of this, the graph representation 640 can be restructured in pre-processing to make it similar to a molecule.

While graph representations are depicted in FIGS. 6B and 6C, it is contemplated that boundary representations can be used, as described herein.

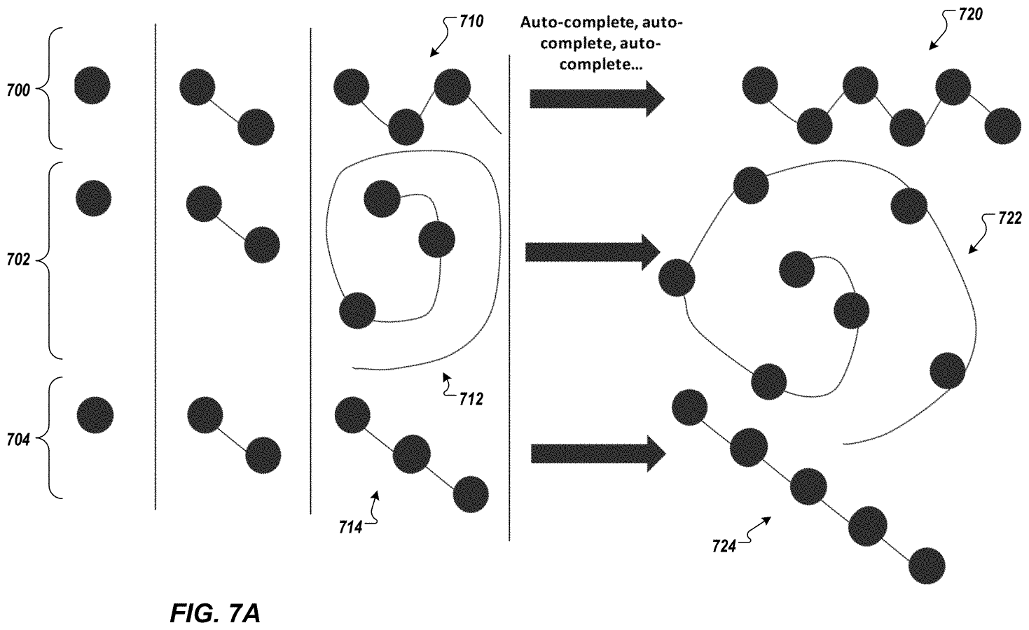

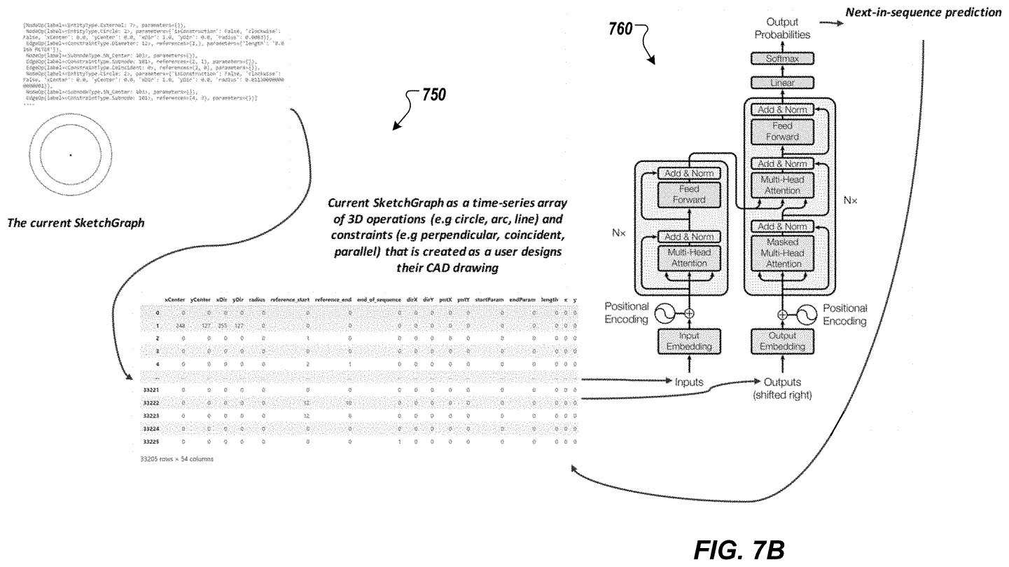

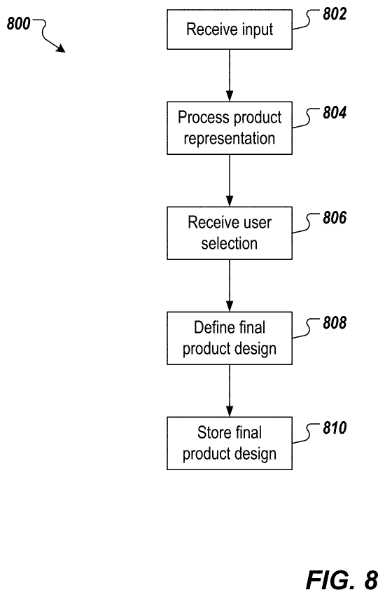

FIGS. 7A and 7B depict representations corresponding to an auto-complete assistant in accordance with implementations of the present disclosure. In some implementations, the auto-complete assistant provides one or more auto-completions for a current product design during progression of the current product design. In some examples, the auto-complete assistant processes a product representation of the current product design through a ML model to provide one or more next-in-sequence predictions used as auto-completions for the current product design. While graph representations are depicted in FIGS. 7A and 7B, it is contemplated that boundary representations can be used, as described herein.

In general, while creating a part, some operations might be tedious and/or resource intensive. For example, array/matrix operations may require many adjustments to create the right look and feel for a product design. To address this, the present disclosure provides the auto-complete assistant that automates these adjustments as a sequence of auto-completions, which the user can select to confirm.

With particular reference to FIG. 7A, example design sequences 700, 702, 704 are depicted. A graph representation 710, 712, 714 of the design sequences 700, 702, 704, respectively, can be processed by the auto-complete assistant to provide an auto-completion 720, 722, 724, respectively.

With particular reference to FIG. 7B, a graph representation 750 is processed through a ML model 760 to provide a next-in-sequence prediction that can be added to the graph representation as an auto-completion. In the example of FIG. 7B, the ML model 760 is provided as the Transformer, which is described in detail in Attention Is All You Need, Vaswani et al., 31st Conference on Neural Information Processing Systems (NIPS 2017), Long Beach, Calif., USA, which is expressly incorporated herein by reference in the entirety. The Transformer is described as a model architecture that uses an attention mechanism to draw global dependencies between input and output. It is contemplated, however, that implementations of the auto-complete assistant of the present disclosure can be realized using any appropriate ML model.

In some implementations, the ML model 760 processes the graph representation to provide a set of predictions. In some examples, the set of predictions includes one or more predictions. In some examples, each prediction includes one or more operations and/or one or more constraints that can be added to the graph representation 750 to progress the product through the design process. In some examples, a set of next-in-sequence graph representations is provided, each next-in-sequence graph representation includes the graph representation 750 as modified based on a prediction in the set of predictions. In some examples, the set of next-in-sequence graph representations can be conveyed to the user, and the user can select a next-in-sequence graph representation as the next iteration of the product design. For example, each next-in-sequence graph representation can be processed to provide a visual display of the product design, as represented by the next-in-sequence graph representation, and the user can make a selection. In some examples, the user need not make a selection and can continue with the design process.

FIG. 8 depicts an example process 800 that can be executed in accordance with implementations of the present disclosure. In some examples, the example process 800 is provided using one or more computer-executable programs executed by one or more computing devices.

Input is received (802). For example, and as described herein, a user provides input to a CAD program through, for example, a UI. The user input can include a selection of one or more of shapes, characteristics of shapes, components, and the like, of a product design. For example, and without limitation, the user input can indicate a shape (e.g., square, rectangle, circle), dimensions of the shape (e.g., length, width, diameter), and a location of the shape in multi-dimensional space (e.g., [X, Y, Z] coordinates of a root of the shape). As another example, and without limitation, the user input can include a relationship between shapes (e.g., a line tangential to a circle, rectangles connected along an edge). As also described herein, a product representation is provided for the product design, the product representation including one of a graph representation (e.g., sketch graph) and a boundary representation (e.g., BRep). In some examples, the product design evolves along a progression of user input and, as the product progresses, the product representation also progresses. As such, a product representation of the product design is provided at respective instances of the progression.

The product representation is processed (804). For example, and as described herein, the product representation can be processed by one or more intelligent assistants in a set of intelligent assistants, each intelligent assistant providing an output as a proposal for progression of the product design. In some examples, the product representation is processed to provide one or more of a set of similar product designs, a set of profiles to the product design, a set of segments of the product design, a set of variant product designs, and one or more auto-completions to the product design. For example, and as described in detail herein, the search assistant processes the product representation during a progression, provides a vector representation of the product design, and identifies, based on the vector representation, one or more previous product designs to recommend to the product designer. As another example, and as described in detail herein, the templating assistant processes the product representation, checks for node isomorphism between one or more nodes of the product design and one or more previous product designs, and recommends one or more of adapters, terminators, and connectors for the product design based on identified node isomorphism. As another example, and as described in detail herein, the segmentation assistant parses the product representation into communities, determines a manufacturability for each community, and recommends the one or more segments based on a community and respective manufacturability. As another example, and as described in detail herein, the design synthesis assistant processes the product representation through a ML model to generate one or more alternative representations, each alternative representation being an alternative design that can be recommended to the product designer. As another example, and as described in detail herein, the auto-complete assistant processes the product representation through a ML model to provide one or more next-in-sequence predictions used as auto-completions for the product design.

A user selection is received (806). For example, and as described herein, the user can select one or more of a similar product design, a profile to the product design, a segment of the product design, a variant product design, and an auto-completion to the product design. A final product design is defined (808). For example, and as described herein, the product design progresses to a final product design, which includes one or more user selections. For example, the final product design can include one or more of a similar product design, a profile to the product design, a segment of the product design, a variant product design, and an auto-completion to the product design provided from the set of intelligent assistants and selected by the user. The final product design is stored (810). For example, and as described herein, the final product design is stored in a computer-readable file in memory.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the to be filed claims.

What is claimed is:

1. A computer-implemented method for computer-aided design (CAD), the method comprising:
receiving input to a CAD program representative of a product design, the input being used to provide a product representation comprising one of a graph representation and a boundary representation;
processing the product representation using an intelligent assistant of a set of intelligent assistants to provide one of a set of similar product designs, a set of profiles to the product design, a set of segments of the product design, a set of variant product designs, and one or more auto-completions to the product design;
receiving input to the CAD program representative of a selection of one or a similar product design, a profile to the product design, a segment of the product design, a variant product of the product design, and an auto-completion of the product design;
defining a final product design at least partially based on the input representative of a selection of one or a similar product design, a profile to the product design, a segment of the product design, a variant product of the product design, and an auto-completion of the product design; and
storing the final product design in a computer-readable file.

2. The method of claim 1, wherein the intelligent assistant comprises a search assistant that processes a product embedding generated from the product representation to provide the set of similar product designs by comparing the product embedding to respective product embeddings of each of the similar product designs in the set of similar product design.

3. The method of claim 1, wherein the intelligent assistant comprises a templating assistant that provides the set of profiles to the product design by processing the product representation to identify instances of node isomorphism between one or more nodes of the product representation and profile representations of each profile in the set of profiles.

4. The method of claim 1, wherein the intelligent assistant comprises a segmentation assistant that provides the set of segments for the product design, each segment representing a sub-part of the product design by parsing the product representation of the product design into communities, determining a manufacturability for each community, and defining the set of segments based on a community and respective manufacturability.

5. The method of claim 1, wherein the intelligent assistant comprises a design synthesis assistant that processes the product representation through a machine learning (ML) model to generate the set of variant product designs, each variant product design being an alternative to the product design.

6. The method of claim 1, wherein the intelligent assistant comprises an auto-complete assistant that provides the set of auto-completions during progression of the product design by processing the product representation through a machine learning (ML) model to provide each auto-completion as a next-in-sequence predictions usable to progress the product design.

7. The method of claim 1, wherein the graph representation represents objects and characteristics of objects of the product design, and the boundary representation represents boundaries and characteristics of boundaries of the product design.

8. A non-transitory computer-readable storage medium coupled to one or more processors and having instructions stored thereon which, when executed by the one or more processors, cause the one or more processors to perform operations for computer-aided design (CAD), the operations comprising:
receiving input to a CAD program representative of a product design, the input being used to provide a product representation comprising one of a graph representation and a boundary representation;
processing the product representation using an intelligent assistant of a set of intelligent assistants to provide one of a set of similar product designs, a set of profiles to the product design, a set of segments of the product design, a set of variant product designs, and one or more auto-completions to the product design;
receiving input to the CAD program representative of a selection of one or a similar product design, a profile to the product design, a segment of the product design, a variant product of the product design, and an auto-completion of the product design;
defining a final product design at least partially based on the input representative of a selection of one or a similar product design, a profile to the product design, a segment of the product design, a variant product of the product design, and an auto-completion of the product design; and
storing the final product design in a computer-readable file.

9. The non-transitory computer-readable storage medium of claim 8, wherein the intelligent assistant comprises a search assistant that processes a product embedding generated from the product representation to provide the set of similar product designs by comparing the product embedding to respective product embeddings of each of the similar product designs in the set of similar product design.

10. The non-transitory computer-readable storage medium of claim 8, wherein the intelligent assistant comprises a templating assistant that provides the set of profiles to the product design by processing the product representation to identify instances of node isomorphism between one or more nodes of the product representation and profile representations of each profile in the set of profiles.

11. The non-transitory computer-readable storage medium of claim 8, wherein the intelligent assistant comprises a segmentation assistant that provides the set of segments for the product design, each segment representing a sub-part of the product design by parsing the product representation of the product design into communities, determining a manufacturability for each community, and defining the set of segments based on a community and respective manufacturability.

12. The non-transitory computer-readable storage medium of claim 8, wherein the intelligent assistant comprises a design synthesis assistant that processes the product representation through a machine learning (ML) model to generate the set of variant product designs, each variant product design being an alternative to the product design.

13. The non-transitory computer-readable storage medium of claim 8, wherein the intelligent assistant comprises an auto-complete assistant that provides the set of auto-completions during progression of the product design by processing the product representation through a machine learning (ML) model to provide each auto-completion as a next-in-sequence predictions usable to progress the product design.

14. The non-transitory computer-readable storage medium of claim 8, wherein the graph representation represents objects and characteristics of objects of the product design, and the boundary representation represents boundaries and characteristics of boundaries of the product design.

15. A system, comprising:
a computing device; and
a computer-readable storage device coupled to the computing device and having instructions stored thereon which, when executed by the computing device, cause the computing device to perform operations for computer-aided design (CAD), the operations comprising:
receiving input to a CAD program representative of a product design, the input being used to provide a product representation comprising one of a graph representation and a boundary representation;
processing the product representation using an intelligent assistant of a set of intelligent assistants to provide one of a set of similar product designs, a set of profiles to the product design, a set of segments of the product design, a set of variant product designs, and one or more auto-completions to the product design;
receiving input to the CAD program representative of a selection of one or a similar product design, a profile to the product design, a segment of the product design, a variant product of the product design, and an auto-completion of the product design;
defining a final product design at least partially based on the input representative of a selection of one or a similar product design, a profile to the product design, a segment of the product design, a variant product of the product design, and an auto-completion of the product design; and
storing the final product design in a computer-readable file.

16. The system of claim 15, wherein the intelligent assistant comprises a search assistant that processes a product embedding generated from the product representation to provide the set of similar product designs by comparing the product embedding to respective product embeddings of each of the similar product designs in the set of similar product design.

17. The system of claim 15, wherein the intelligent assistant comprises a templating assistant that provides the set of profiles to the product design by processing the product representation to identify instances of node isomorphism between one or more nodes of the product representation and profile representations of each profile in the set of profiles.

18. The system of claim 15, wherein the intelligent assistant comprises a segmentation assistant that provides the set of segments for the product design, each segment representing a sub-part of the product design by parsing the product representation of the product design into communities, determining a manufacturability for each community, and defining the set of segments based on a community and respective manufacturability.

19. The system of claim 15, wherein the intelligent assistant comprises a design synthesis assistant that processes the product representation through a machine learning (ML) model to generate the set of variant product designs, each variant product design being an alternative to the product design.

20. The system of claim 15, wherein the intelligent assistant comprises an auto-complete assistant that provides the set of auto-completions during progression of the product design by processing the product representation through a machine learning (ML) model to provide each auto-completion as a next-in-sequence predictions usable to progress the product design.
